(19) United States
(12) Patent Application Publication
(10) Pub. No.: US 2006/0128531 A1
(43) Pub. Date: Jun. 15, 2006

(54) Training apparatus

(76) Inventor: Tore Planke, Tvedestrand (NO)

Correspondence Address: RODMAN RODMAN, 7 SOUTH BROADWAY, WHITE PLAINS, NY, 10601, US

(21) Appl. No.: 10/525,436

(22) PCT Filed: Aug. 27, 2003
(86) PCT No.: PCT/NO03/00299

§ 371 Date: Jul. 25, 2005

(30) Foreign Application Priority Data
Aug. 30, 2002 (NO) 20024160

(51) Int. Cl. A63B 1/00; A61H 3/00; A63B 21/068; A47D 13/04

(52) U.S. Cl. 482/39; 482/95; 482/69

(57) ABSTRACT

A training apparatus consisting of a rope (2) which can be passed via a suspended direction reversal means (1), wherein a first part (2′) of the rope is arranged to hang down from one side of the direction reversal means, wherein a handle loop (3) is provided at one end (2″) of the first part (2′) of the rope, and wherein a second part (2′″) of the rope is arranged to hang down from another side of the direction reversal means and is designed to form releasable engagement with a locking device (4, 4′) of the key way type, so-called “Cleatlock”. The locking device (4) is secured to the first part of the rope, and the direction reversal means (1) is selected from the group consisting of: a beam, a bar, a guide tube, a guide channel, a pulley and a suspension bracket.

The present invention relates to a training apparatus consisting of a rope that can be passed via a suspended direction reversal means, wherein a first part of the rope is arranged to hang down from one side of the direction reversal means, wherein a handle loop is provided at one end of the first part of the rope, and wherein a second part of the rope is arranged to hang down from another side of the direction reversal means and is designed to form releasable engagement with a locking device of the key way type, so-called “Cleatlock”.

An apparatus of this kind is known from Norwegian Patent 161418. The known apparatus has two mutually independent ropes with respective direction reversal means, locking device and handle loop, and the direction reversal means are spaced apart at a fixed distance.

However, there has been a desire to find a training apparatus which is both cheaper to produce and easier to assemble in certain cases, and which permits the installation of just one rope and handle loop or two or more thereof, depending upon the need of the individual.

According to the invention, the apparatus mentioned above is characterised in that the locking device is attached to the first part of the rope, and that the direction reversal means is selected from the group consisting of: a beam, a bar, a guide tube, a guide channel, a pulley and a suspension bracket.

According to an another embodiment of the apparatus, wherein the direction reversal means is a suspension bracket, the bracket is made in the form of a U-shaped structure, and the arms of the U are hooked at their respective free ends. The distance between the arms of the U-shaped bracket may be adjustable, preferably for suspension from the upper door frame architraves of a door, and the arms may respectively have a perforated portion for the rope for the purpose of forming said direction reversal means.

According to one embodiment of the invention, the locking device is equipped with a retaining slot or clamp for the first part of the rope, and the locking device has in connection with the cleatlock part a guide, e.g., a guide belt or guide flap, which covers at least a portion of the opening of the key way part

The purpose of the guide is to limit the movement of the rope out of the cleatlock, i.e., also transverse to the locking part, when the second part of the rope is manipulated to adjust the engagement of the key way with the rope. Advantageously, the guide is elastically yielding.

According to another embodiment, the cleatlock part of the locking device has at an upper end thereof a rope insertion groove for sideways insertion of the second part of the rope, and wherein said guide is designed to be positioned after insertion of the second part of the rope in order to limit the sideways movement of the rope part relative to the locking part of the locking device.

The invention will now be described in more detail with reference to the attached drawings.

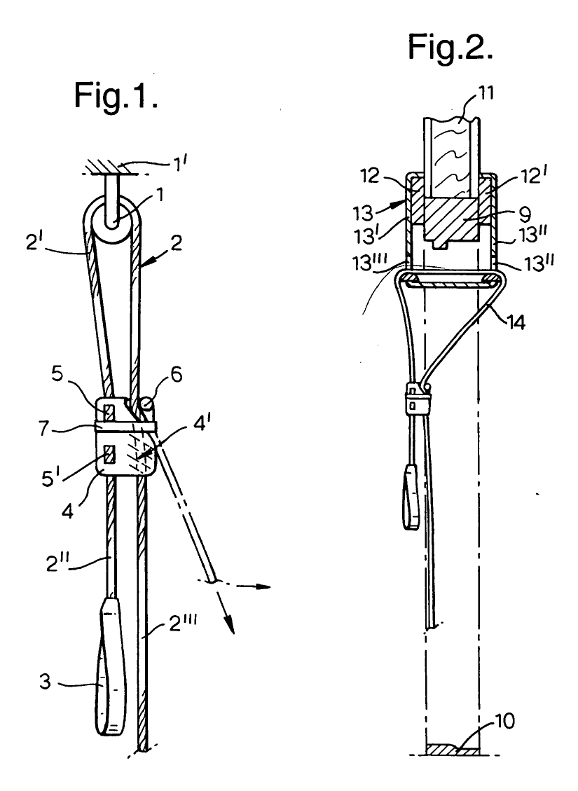

FIG. 1 shows an embodiment of the apparatus in a first mode of use according to the invention.

FIG. 2 shows a device in a second mode of use in cooperation with a suspension bracket.

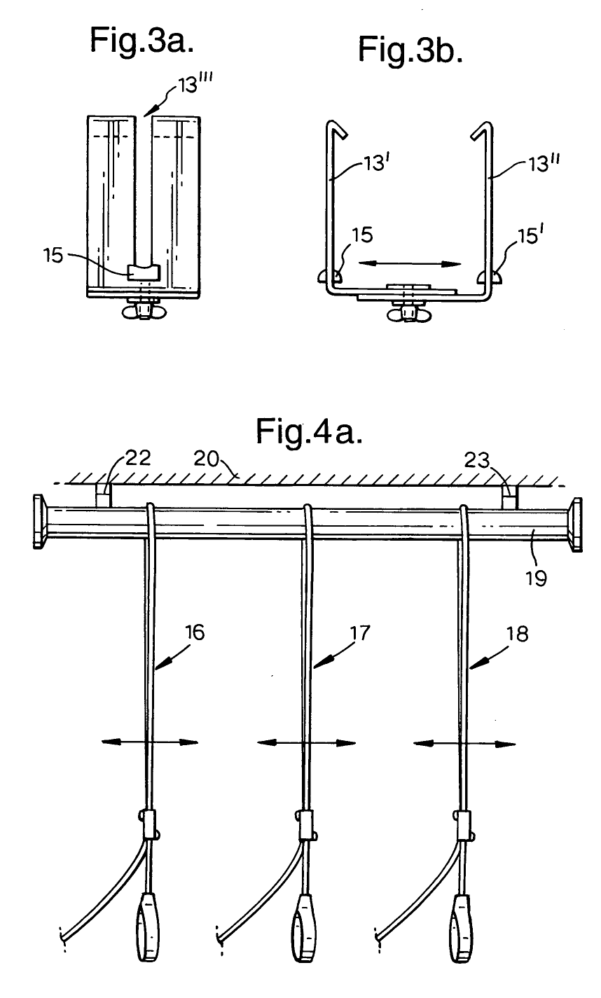

FIG. 3a and FIG. 3b show details of the suspension bracket as shown in FIG. 2.

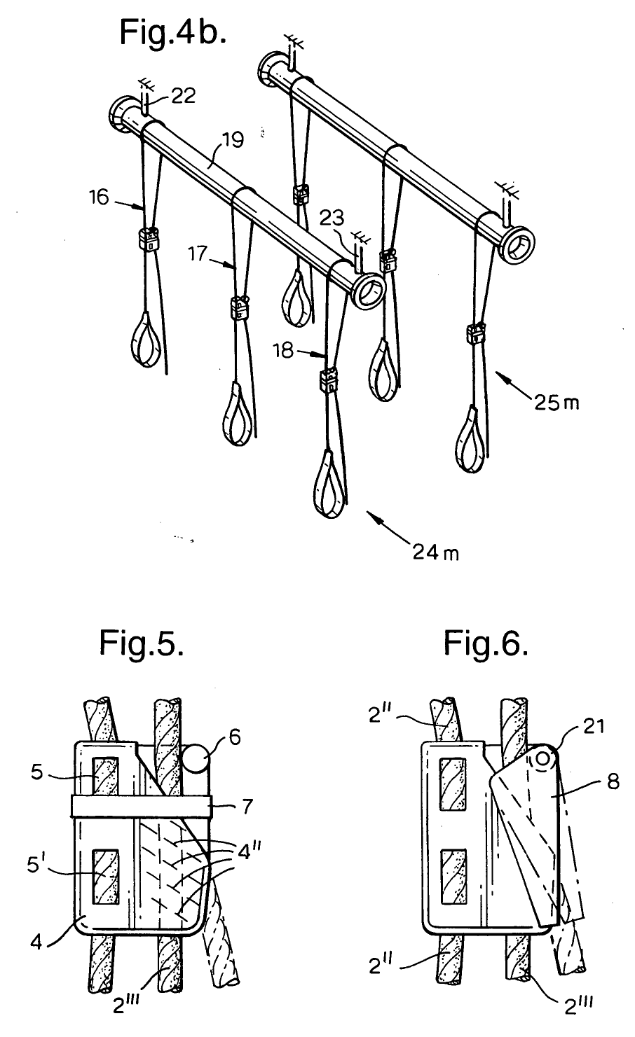

FIG. 4a shows a third mode of use of the apparatus, and FIG. 4b shows a variant use thereof.

FIG. 5 shows details of the locking device that is an integral part of the apparatus.

FIG. 6 shows a modification of the locking device according to FIG. 2.

FIG. 1 shows a direction reversal means 1, e.g., a beam, bar, pulley or the like which is secured to a support 1′, e.g., a frame structure or a building structure as for example a ceiling or door opening, over which is passed a rope 2 which in a first part 2′ that hangs down on one side of the direction reversal means at one end 2″ becomes a handle loop 3 and some distance above the handle loop is secured in a locking device 4, and which at the second end 2′″ that hangs down on the other side of the direction reversal means is in releasable engagement with the locking part 4′ of key way type (so-called “Cleatlock”) on the locking device 4. The rope part 2′ is attachable to the locking device by means of, e.g., retaining slots 5, 5′, but can of course be attached by means of adhesive, clamps, rivets etc. Advantageously, there is on the locking device 4 above the locking part 4′ a guide pin 6 for ensuring that the rope part 2′″ cannot be easily pulled out of the locking part 4′. A guide, e.g., in the form of a guide belt 7 or a guide flap 8, preferably outwardly pivotal against spring force, is intended to cover at least a part of the opening of the locking part 4′, so that when the rope part 2′″ is pulled out to the side for upward or downward adjustment of the loop 3, there is no risk of the rope part 2′″ being pulled out so far that it exits the locking device 4.

When the rope part 2′″ is released, it will slide inside the locking part 4′ and be held by wedging there by the key way 4″, see FIG. 5.

FIG. 2 shows how the apparatus according to the invention can be suspended from the upper door frame architraves of a door, and FIG. 3 shows the suspension bracket in more detail. In FIG. 2 the upper door frame member is indicated by the reference numeral 9, the door sill by the numeral 10, the wall structure by the numeral 11 and upper architraves (horizontal) by the numerals 12, 12′. The suspension fitting—or the bracket 13 consists, as shown in FIG. 3a and FIG. 3b, of two mutually movable parts 13′, 13″, each of which has an opening 13′″ for insertion of the rope 14 (corresponding to the rope 2 in FIG. 1). A sliding guide 15, respectively 15′ may be provided at the bottom of the opening. Alternatively, the sliding guide may be in the form of a roller or pulley (not shown). It is also possible that the suspension bracket, which has an approximate U-shape, may have arms which, e.g., can be bent away from each other in an elastically yielding manner so as to be able to grip the architraves by pure spring force.

FIG. 4a shows how, e.g., two or three units 16, 17, 18 consisting of rope with respective locking device and respective loop, according to the invention, can be suspended from a common direction reversal means 19, e.g., a bar, and where the direction reversal means is mounted on, e.g., a ceiling 20, via hooks 22, 23 which e.g., are spaced 60 cm or 120 cm apart.

Although three such units are shown, it would be possible to suspend more or fewer units according to need. Of course, it is also possible to have two parallel supports as shown in FIG. 4b with respectively m and n units for attached to respectively the units 24m and 25n, wherein m=1, 2, 3 . . . and n=1, 2, 3 . . . , and wherein m=n or m≠n. As shown, the rope will be passed around a part of the circumference of the beam or bar.

FIG. 5 shows that described in connection with FIG. 1 in more detail, and the difference between FIG. 5 and FIG. 6 is that FIG. 5 shows the guide belt 7, whilst in FIG. 6 this belt has been replaced by the guide flap 8. When the rope 2′″ is to be passed into the locking part 4′ of the locking device 4 for the first time, the belt will be held away from the locking device 4, but subsequently slipped into place thereon. When using the guide flap 8, the flap is turned (to the right in the figure) to the side and upwards about a pivot point 21 on the device 4, so that the rope 2′″ may easily be placed inside the locking part, whereupon the flap is turned back to the position as shown. The flap 8 may be spring-loaded (not shown), but if the pivot mounting allows the flap to turn easily, spring-loading is not necessary, especially if the flap also has an adapted centre of gravity.

1. A training apparatus consisting of a rope (2) which can be passed via a suspended direction reversal means (1), wherein a first part (2′) of the rope is arranged to hang down from one side of the direction reversal means, wherein a handle loop (2″) is provided at one end of the first part (2′) of the rope, and wherein a second part (2′″) of the rope is arranged to hang down from another side of the direction reversal means and is designed to form releasable engagement with a locking device (4) of key way type (4″), so-called “Cleatlock”,
characterised in
that the locking device (4) is attached to the first part (2′) of the rope.

2. An apparatus as disclosed in claim 1, characterised in
that the locking device (4) is equipped with a retaining slot or clamp (5, 5′) for the first part (2′) of the rope; and
that the locking device (4) has in connection with its key way-equipped (4″) locking part (4′) a guide (7; 8) for the second part of the rope, e.g., guide belt (7) or guide flap (8), which covers at least a portion of the opening of the locking part (4′).

3. An apparatus as disclosed in claim 2, characterised in
that the guide (7; 8) is arranged to limit the movement of the second part (2′″) of the rope out of the key way (4″) when this rope part (2′″) is manipulated in order to adjust the engagement of the key way (4″) with the second part (2′″) of the rope.

4. An apparatus as disclosed in claim 2, characterised in
that the guide (7; 8) is made to be elastically yielding.

5. An apparatus as disclosed in claim 2, characterised in
that the key way part (4′, 4″) of the locking device (4) at an upper end thereof has a rope insertion groove for sideways insertion of the second part (2′″) of the rope; and
that said guide (7; 8) is designed to be positioned after insertion of the second part (2′″) of the rope into the locking device (4) in order to limit the sideways movement of the second part (2′″) of the rope relative to the locking part (4′) of the locking device (4).

6. A suspended direction reversal means for cooperation with an apparatus as disclosed in claim 1, characterised in
that the direction reversal means is a suspension bracket in the form of a U-shaped structure (13), wherein the arms (13, 13′) of the U are hooked at their respective free ends;
that the distance between the arms (13, 13′) of the U-shaped bracket is adjustable, preferably for suspension from the architraves (12, 12′) of the upper door frame of a door; and
that the two arms each have a perforated portion (13′″, 13″″) for the rope (2) for the purpose of forming said direction reversal means.
